(19) United States
(12) Patent Application Publication
(10) Pub. No.: US 2021/0223063 A1
(43) Pub. Date: Jul. 22, 2021

(54) POSITION DETECTING DEVICE OF APERTURE MODULE

(71) Applicant: Samsung Electro-Mechanics Co., Ltd., Suwon-si (KR)

(72) Inventors: Je Hyeon YU, Suwon-si (KR); Joon Hyung LIM, Suwon-si (KR); Ji Buem CHUN, Suwon-si (KR); Ji Hwan KIM, Suwon-si (KR)

(73) Assignee: Samsung Electro-Mechanics Co., Ltd., Suwon-si (KR)

(21) Appl. No.: 16/855,172

(22) Filed: Apr. 22, 2020

(30) Foreign Application Priority Data
Jan. 20, 2020 (KR) 10-2020-0007300

(51) Int. Cl. G01D 5/14; G02B 7/02; G11B 7/09; H04N 5/225

(52) U.S. Cl. CPC G01D 5/145; H04N 5/2254; G11B 7/0935; G02B 7/023

(57) ABSTRACT

A position detecting device includes a first hall device and a second hall device; a subtractor to subtract a second hall voltage generated by the second hall device from a first hall voltage generated by the first hall device to generate a subtraction voltage; an adder to add the first hall voltage to the second hall voltage to generate an addition voltage; and a divider to calculate a ratio of the addition voltage to the subtraction voltage in accordance with a charging time of a capacitor using the addition voltage and a discharging time of the capacitor using the subtraction voltage.

### CROSS-REFERENCE TO RELATED APPLICATION(S)

This application claims the benefit under 35 USC 119(a) of Korean Patent Application No. 10-2020-0007300 filed on Jan. 20, 2020 in the Korean Intellectual Property Office, the entire disclosure of which is incorporated herein by reference for all purposes.

### BACKGROUND

### 1. Field

The following description relates to a position detecting device of an aperture module.

### 2. Description of Background

Generally, portable communications terminals such as mobile phones, personal digital assistants (PDAs), portable personal computers (PCs), and the like, have been designed to transmit text data or voice data and to also transmit image data. Accordingly, a camera module has been installed in a portable communication terminal to allow for transmission of image data and provide a video chat function.

A camera module may include an aperture module for adjusting an amount of light incident to a lens barrel. An aperture module may move an aperture to a target point by electromagnetic interaction between a coil and a magnet. An aperture module may detect a current position of an aperture by sensing a position of a magnet using a hall device.

A hall voltage of a hall device, however, may change according to changes in temperature. Thus, it may be necessary to compensate for changes in hall voltage caused by changes in temperature to detect an accurate position of a magnet or an aperture.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

A position detecting device of an aperture module which may compensate for changes in hall voltage caused by changes in temperature.

In one general aspect, a position detecting device includes a first hall device and a second hall device; a subtractor to subtract a second hall voltage generated by the second hall device from a first hall voltage generated by the first hall device to generate a subtraction voltage; an adder to add the first hall voltage to the second hall voltage to generate an addition voltage; and a divider to calculate a ratio of the addition voltage to the subtraction voltage in accordance with a charging time of a capacitor using the addition voltage and a discharging time of the capacitor using the subtraction voltage.

The divider may include a dual-slope integrating analog-to-digital converter (ADC).

The divider may calculate the ratio of the addition voltage to the subtraction voltage in accordance with a ratio of the charging time to the discharging time.

In a case in which the capacitor has a first voltage level and is charged according to the addition voltage, the divider may calculate the charging time by measuring a time taken for a voltage of the capacitor to reach a second voltage level.

In a case in which the capacitor has the second voltage level and is discharged according to the subtraction voltage, the divider may calculate the discharging time by measuring a time taken for a voltage of the capacitor to reach the first voltage level.

The charging time of the capacitor using the addition voltage may be different from the discharging time of the capacitor using the subtraction voltage.

Changes in voltage according to temperatures of the first hall voltage and the second hall voltage may be removed in accordance with the ratio of the addition voltage to the subtraction voltage.

The position detecting device may include a first differential amplifier to differential-amplify two output voltages of the first hall device to generate the first hall voltage; and a second differential amplifier to differential-amplify two output voltages of the second hall device to generate the second hall voltage.

In another general aspect, a position detecting device includes a first hall device and a second hall device; an adder to add a first hall voltage generated by the first hall device to a second hall voltage generated by the second hall device to generate an addition voltage; a compensation voltage generator to generate a compensation voltage having temperature properties that are the same as temperature properties of the addition voltage; and a divider to calculate a ratio of the addition voltage to the compensation voltage in accordance with a charging time of a capacitor using the addition voltage and a discharging time of the capacitor using the compensation voltage.

The divider may calculate the ratio of the addition voltage to the compensation voltage in accordance with a ratio of the charging time to the discharging time.

In a case in which the capacitor has a first voltage level and is charged in accordance with the addition voltage, the divider may calculate the charging time by measuring a time taken for a voltage of the capacitor to reach a second voltage level.

In a case in which the capacitor has the second voltage level and is discharged according to the compensation voltage, the divider may calculate the discharging time by measuring a time taken for a voltage of the capacitor to reach the first voltage level.

The charging time of the capacitor using the addition voltage may be different from the discharging time of the capacitor using the compensation voltage.

Changes in voltage according to temperatures of the first hall voltage and the second hall voltage may be removed in accordance with the ratio of the addition voltage to the compensation voltage.

The position detecting device may include a first differential amplifier to differential-amplify two output voltages of the first hall device to generate the first hall voltage; and a second differential amplifier to differential-amplify two output voltages of the second hall device to generate the second hall voltage.

In another general aspect, a camera module includes a lens barrel and an aperture module to adjust an amount of light incident to the lens barrel. The aperture module includes a coil; a magnet that opposes the coil along a first direction perpendicular to an optical axis; a first hall device to generate a first hall voltage; a second hall device configured to generate a second hall voltage; and a position detection device to detect a current position of an aperture of the aperture module by sensing a position of the magnet based on a ratio of a sum of the first hall voltage and the second hall voltage to a difference between the first hall voltage and the second hall voltage.

The first hall device may be disposed on a first side of the coil along a second direction that is perpendicular to the first direction and the optical axis, and the second hall device may be disposed on a second side of the coil along the second direction.

Other features and aspects will be apparent from the following detailed description, the drawings, and the claims.

### BRIEF DESCRIPTION OF DRAWINGS

FIG. 1 is a perspective diagram illustrating a camera module according to an example.

FIG. 2 is an exploded perspective diagram illustrating a camera module according to an example.

FIG. 3 is a block diagram illustrating an aperture module employed in a camera module according to an example.

FIG. 4 is a block diagram illustrating a position detecting device according to an example.

FIG. 5 is a block diagram illustrating a position detecting device according to an example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

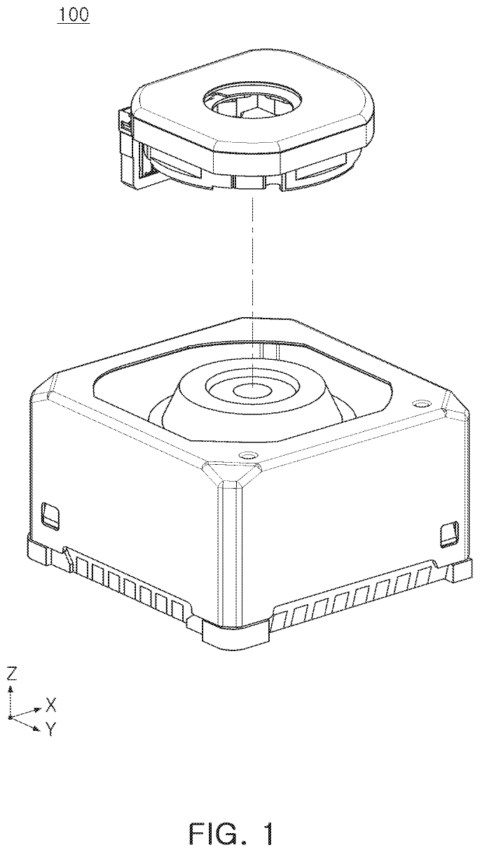

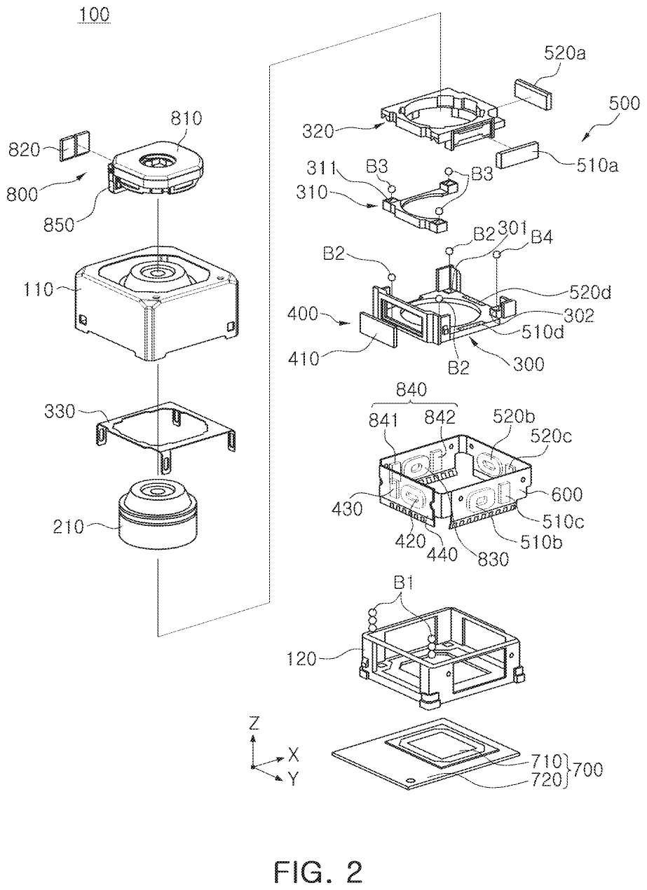

FIG. 1 is a perspective diagram illustrating a camera module according to an example. FIG. 2 is an exploded perspective diagram illustrating a camera module according to an example.

Referring to FIGS. 1 and 2, a camera module 100 may include a lens barrel 210, an actuator for moving the lens barrel 210, a case 110 and a housing 120 for accommodating the lens barrel 210 and the actuator, an image sensor module 700 converting light incident through the lens barrel 210 into an electrical signal, and an aperture module 800 adjusting an amount of light incident to the lens barrel 210.

The lens barrel 210 may have a cylindrical hollow shape, such that a plurality of lenses for imaging an object may be accommodated in the lens barrel 210, and the plurality of lenses may be mounted on the lens barrel 210 along an optical axis (Z axis in FIGS. 1 and 2). A desired number of lenses may be disposed in various examples, and the lenses may have the same refractive index and the same optical properties, or may have different refractive indices and different optical properties.

The actuator may move the lens barrel 210. As an example, the actuator may adjust a focus by moving the lens barrel 210 in a direction of an optical axis (a Z axis), and the actuator may perform an image-shake correction function when an object is imaged by moving the lens barrel 210 in a direction perpendicular (X axis or Y axis) to the optical axis (the Z axis). The actuator may include a focus adjustment unit 400 for adjusting a focus and a shake correction unit 500 for correcting the shaking of an image.

The image sensor module 700 may convert light incident through the lens barrel 210 into an electrical signal. As an example, the image sensor module 700 may include an image sensor 710 and a printed circuit board 720 connected to the image sensor 710, and may further include an infrared filter. The infrared filter may block infrared light of light incident through the lens barrel 210. The image sensor 710 may convert light incident through the lens barrel 210 into an electrical signal. As an example, the image sensor 710 may include a charge coupled device (CCD) or a complementary metal-oxide semiconductor (CMOS). An electrical signal converted by the image sensor 710 may be output as an image through a display unit of a portable electronic device. The image sensor 710 may be fixed to the printed circuit board 720, and may be electrically connected to the printed circuit board 720 by a wire bonding.

The lens barrel 210 and the actuator may be accommodated in the housing 120. As an example, an upper portion and a lower portion of the housing 120 may be configured to be open, and the lens barrel 210 and the actuator may be accommodated in the housing 120. The image sensor module 700 may be disposed below the housing 120.

The case 110 may be coupled to the housing 120 to enclose an external surface of the housing 120, and may protect internal components of the camera module 100. The case 110 may also shield electromagnetic waves. The case 110 may be formed of a metal material and may be grounded to a ground pad provided in the printed circuit board 720, and may shield electromagnetic waves.

In the example, the actuator may move the lens barrel 210 to focus on an object. As an example, the actuator may include the focus adjustment unit 400 for moving the lens barrel 210 in the direction of the optical axis (the Z axis).

The focus adjustment unit 400 may include a magnet 410 for generating driving force to move the lens barrel 210, a carrier 300 in which the lens barrel 210 is accommodated in the direction of the optical axis (the Z axis), and a coil 420.

The magnet 410 may be mounted on the carrier 300. As an example, the magnet 410 may be mounted on a first surface of the carrier 300. The coil 420 may be mounted on the housing 120 and may oppose the magnet 410. As an example, the coil 420 may be disposed on a first surface of a substrate 600, and the substrate 600 may be mounted on the housing 120.

The magnet 410 may be mounted on the carrier 300 and may move in the direction of the optical axis (the Z axis) together with the carrier 300, and the coil 420 may be fixed to the housing 120. In various examples, the positions of the magnet 410 and the coil 420 may be exchanged with each other.

When a driving signal is applied to the coil 420, the carrier 300 may move in the direction of the optical axis (the Z axis) due to electromagnetic interaction between the magnet 410 and the coil 420.

The lens barrel 210 may be accommodated in the carrier 300, and the lens barrel 210 may also move in the direction of the optical axis (the Z axis) as the carrier 300 moves. A frame 310 and a lens holder 320 may also be accommodated in the carrier 300, and the frame 310, the lens holder 320, and the lens barrel 210 may move in the direction of the optical axis (the Z axis) together as the carrier 300 moves.

When the carrier 300 moves, a rolling member B1 may be disposed between the carrier 300 and the housing 120 to reduce friction between the carrier 300 and the housing 120. The rolling member B1 may have a form of a ball, or a plurality of balls. The rolling member B1 may be disposed on both sides of the magnet 410.

A yoke 440 may be disposed in the housing 120. As an example, the yoke 440 may be mounted on the substrate 600 and may be disposed in the housing 120. The yoke 440 may be arranged on another surface of the substrate 600. Accordingly, the yoke 440 may oppose the magnet 410 with the coil 420 interposed therebetween. Attractive force may work between the yoke 440 and the magnet 410 in a direction perpendicular to the optical axis (the Z axis). By the attractive force between the yoke 440 and the magnet 410, the rolling member B1 may maintain a state of being in contact with the carrier 300 and the housing 120. Also, the yoke 440 may collect magnetic force of the magnet 410 and may prevent leakage flux. As an example, the yoke 440 and the magnet 410 may form a magnetic circuit.

In the example, in the process of adjusting a focus, a closed-loop control method of sensing a position of the lens barrel 210 and providing feedback may be used. Accordingly, the focus adjusting unit may include a position detecting device for the closed-loop control. As an example, the position detecting device may include an AF hall device 430. A flux value detected from the AF hall device 430 may change in accordance with the movement of the magnet 410 opposing the AF hall device 430. The position detecting device may detect a position of the lens barrel 210 from changes in flux value of the AF hall device 430 caused by the movement of the magnet 410 in the direction of the optical axis (the Z axis).

The shake correction unit 500 may be used to correct the blurring of an image or the shaking of a video caused by a factor such as shaking of a user's hand when an image or a video is captured. For example, when the image shakes due to the shaking of a user's hand while an image is captured, the shake correction unit 500 may provide a relative displacement corresponding the shaking to the lens barrel 210 to correct the shaking. As an example, the shake correction unit 500 may correct the shaking by moving the lens barrel 210 in the direction perpendicular to the optical axis (the Z axis).

The shake correction unit 500 may include a plurality of magnets 510a and 520a generating driving force for moving a guiding member in the direction perpendicular to the optical axis (the Z axis) and a plurality of coils 510b and 520b. The frame 310 and the lens holder 320 may be inserted into the carrier 300 and may be disposed in the optical axis (the Z axis), and may guide the movement of the lens barrel 210. The frame 310 and the lens holder 320 may include a space into which the lens barrel 210 is inserted. The lens barrel 210 may be inserted into and fixed to the lens holder 320.

The frame 310 and the lens holder 320 may move in the direction perpendicular to the optical axis (the Z axis) with respect to the carrier 300 by driving force generated by magnetic interaction between the plurality of magnets 510a and 520a and the plurality of coils 510b and 520b. Among the plurality of magnets 510a and 520a and the plurality of coils 510b and 520b, the first magnetic 510a may be disposed on the second surface of the lens holder 320, and the first coil 510b may be disposed on the second surface of the substrate 600 such that the first magnetic 510a and the first coil 510b may generate driving force in a direction of a first axis (a Y axis) perpendicular to the optical axis (the Z axis). Also, the second magnet 520a may be disposed on a third surface of the lens holder 320 and the second coil 520b may be disposed on a third surface of the substrate 600, and the second magnet 520a and the second coil 520b may generate driving force in a direction of a second axis (an X axis) perpendicular to the first axis (the Y axis). The second axis (the X axis) may refer to an axis perpendicular to both the optical axis (the Z axis) and the first axis (the Y axis). The plurality of coils 510b and 520b may be configured to be orthogonal to each other on a planar surface perpendicular to the optical axis (the Z axis).

The plurality of magnets 510a and 520a may be mounted on the lens holder 320, and the plurality of coils 510b and 520b opposing the plurality of magnets 510a and 520a may be disposed on the substrate 600 and may be mounted on the housing 120.

The plurality of magnets 510a and 520a may move in a direction perpendicular to the optical axis (the Z axis) along with the lens holder 320, and the plurality of coils 510b and 520b may be fixed to the housing 120. In various examples, positions of the plurality of magnets 510a and 520a and the plurality of coils 510b and 520b may be reversed with respect to each other.

In the example, in the process of shake correction, a closed-loop control method of sensing a position of the lens barrel 210 and providing feedback may be used. Accordingly, the shake correction unit 500 may include a position detecting device for the closed-loop control. The position detecting device may include OIS hall devices 510c and 520c. The OIS hall devices 510c and 520c may be disposed on the substrate 600, and may be mounted on the housing 120. The OIS hall devices 510c and 520c may oppose the plurality of magnets 510a and 520a in the direction perpendicular to the optical axis (the Z axis). As an example, the first OIS hall device 510c may be disposed on the second surface of the substrate 600, and the second OIS hall device 520c may be disposed on the third surface of the substrate 600.

Flux values of the OIS hall devices 510c and 520c may change in accordance with the movement of the magnets 510a and 520a opposing the OIS hall devices 510c and 520c. The position detecting device may detect a position of the lens barrel 210 from changes in flux values of the OIS hall devices 510c and 520c caused by the movement of the magnets 510a and 520a in two directions (X axis and Y axis directions) perpendicular to the optical axis.

The camera module 100 may include a plurality of ball members supporting the shake correction unit 500. The plurality of ball members may be configured to guide the movements of the frame 310, the lens holder 320, and the lens barrel 210, and also to maintain gaps among the carrier 300, the frame 310, and the lens holder 320.

The plurality of ball members may include a first ball member B2 and a second ball member B3. The first ball member B2 may guide the movements of the frame 310, the lens holder 320, and the lens barrel 210 in the direction of the first axis (the Y axis), and the second ball member B3 may guide the movements of the lens holder 320 and the lens barrel 210 in the direction of the second axis (the X axis).

As an example, when driving force working in the direction of the first axis (the Y axis) occurs, the first ball member B2 may roll in the direction of the first axis (the Y axis). Accordingly, the first ball member B2 may guide the movements of the frame 310, the lens holder 320, and the lens barrel 210 in the direction of the first axis (the Y axis). Also, when driving force working in the direction of the second axis (the X axis) occurs, the second ball member B3 may roll in the direction of the second axis (the X axis). Accordingly, the second ball member B3 may guide the movements of the lens holder 320 and the lens barrel 210 in the direction of the second axis (the X axis).

The first ball member B2 may include a plurality of ball members disposed between the carrier 300 and the frame 310, and the second ball member B3 may include a plurality of ball members disposed between the frame 310 and the lens holder 320.

A first guide groove portion 301 for accommodating the first ball member B2 may be disposed on each of surfaces of the carrier 300 and the frame 310 opposing in the direction of the optical axis (the Z axis). The first guide groove portion 301 may include a plurality of guide grooves corresponding to the plurality of ball members of the first ball member B2. The first ball member B2 may be accommodated in the frame 310 and may be interposed between the carrier 300 and the frame 310. The movement of the first ball member B2 in the directions of the optical axis (the Z axis) and the second axis (the X axis) while the first ball member B2 is accommodated in the first guide groove portion 301, and may only move in the direction of the first axis (the Y axis). As an example, the first ball member B2 may only roll in the direction of the first axis (the Y axis). To this end, a planar surface of each of the plurality of guide grooves of the first guide groove portion 301 may have a rectangular shape having a length in the direction of the first axis (the Y axis).

A second guide groove portion 311 for accommodating the second ball member B3 may be formed on each of surfaces of the frame 310 and the lens holder 320 opposing each other in the direction of the optical axis (the Z axis). The second guide groove portion 311 may include a plurality of guide grooves corresponding to the plurality of ball members of the second ball member B3.

The second ball member B3 may be accommodated in the second guide groove portion 311 and may be interposed between the frame 310 and the lens holder 320. The movement of the second ball member B3 in the directions of the optical axis (the Z axis) and the first axis (the Y axis) may be prevented while the second ball member B3 is accommodated in the second guide groove portion 311, and may only move in the direction of the second axis (the X axis). As an example, the second ball member B3 may only roll in the direction of the second axis (the X axis). To this end, a planar surface of each of the plurality of guide grooves of the second guide groove portion 311 may have a rectangular shape having a length in the direction of the second axis (the X axis).

A third ball member B4 for supporting the movement of the lens holder 320 between the carrier 300 and the lens holder 320 may be provided. The third ball member B4 may guide the movements of the lens holder 320 in the directions of the first axis (the Y axis) and the second axis (the X axis).

As an example, the third ball member B4 may roll in the direction of the first axis (the Y axis) when driving force occurs in the direction of the first axis (the Y axis). Accordingly, the third ball member B4 may guide the movement of the lens holder 320 in the direction of the first axis (the Y axis).

Also, the third ball member B4 may roll in the direction of the second axis (the X axis) when driving force occurs in the direction of the second axis (the X axis). Accordingly, the third ball member B4 may guide the movement of the lens holder 320 in the direction of the second axis (the X axis). The second ball member B3 and the third ball member B4 may be in contact with and may support the lens holder 320.

A third guide groove portion 302 for accommodating the third ball member B4 may be formed on each of surfaces of the carrier 300 and the lens holder 320 opposing each other in the direction of the optical axis (the Z axis). The third ball member B4 may be accommodated in the third guide groove portion 302 and may be interposed between the carrier 300 and the lens holder 320. The movement of the third ball member B4 in the direction of the optical axis (the Z axis) may be prevented while the third ball member B4 is accommodated in the third guide groove portion 302, and may roll only in the directions of the first axis (the Y axis) and the second axis (the X axis). To this end, a planar surface of the third guide groove portion 302 may have a circular shape. Thus, the planar surfaces of the first guide groove portion 301, the second guide groove portion 311, and the third guide groove portion 302 may have different shapes.

The first ball member B2 may roll in the direction of the first axis (the Y axis), the second ball member B3 may roll in the direction of the second axis (the X axis), and the third ball member B4 may roll in the directions of the first axis (the Y axis) and the second axis (the X axis).

When driving force working in the direction of the first axis (the Y axis) occurs, the frame 310, the lens holder 320, and the lens barrel 210 may move in the direction of the first axis (the Y axis). The first ball member B2 and the third ball member B4 may roll in the direction of the first axis (the Y axis). The movement of the second ball member B3 may be prevented.

When driving force working in the direction of the second axis (the X axis) occurs, the lens holder 320 and the lens barrel 210 may move in the direction of the second axis (the X axis). The second ball member B3 and the third ball member B4 may roll in the direction of the second axis (the X axis). The movement of the first ball member B2 may be prevented.

In the example, a plurality of yokes 510d and 520d may be provided such that the shake correction unit 500 and the first to third ball members B2, B3, and B4 may maintain a state of being in contact therebetween. The plurality of yokes 510d and 520d may be fixed to the carrier 300, and may oppose the plurality of magnets 510a and 520a in the direction of the optical axis (the Z axis). Accordingly, attractive force may occur between the plurality of yokes 510d and 520d and the plurality of magnets 510a and 520a. By the attractive force between the plurality of yokes 510d and 520d and the plurality of magnets 510a and 520a, the shake correction unit 500 may be pressured in a direction of the plurality of yokes 510d and 520d, and accordingly, the frame 310 and the lens holder 320 of the shake correction unit 500 may maintain a state of being in contact with the first to third ball members B2, B3, and B4. The plurality of yokes 510d and 520d may be formed of a material which may generate attractive force between the plurality of yokes 510d and 520d and the plurality of magnets 510a and 520a. As an example, the plurality of yokes 510d and 520d may be formed of a magnetic material.

In the example, the plurality of yokes 510d and 520d may be provided such that the frame 310 and the lens holder 320 may maintain a state of being in contact with the first to third ball members B2, B3, and B4, and a stopper 330 may be provided to prevent the first to third ball members B2, B3, and B4, the frame 310, and the lens holder 320 from being detached from the carrier 300. The stopper 330 may be coupled to the carrier 300 to cover at least a portion of an upper surface of the lens holder 320.

The aperture module 800 may include an aperture 810, a magnet 820, a coil 830, a hall device 840, and a substrate 850.

The aperture 810 of the aperture module 800 may be coupled to the lens barrel 210 through an upper portion of the case 110. As an example, the aperture 810 may be mounted on the lens holder 320 to which the lens barrel 210 is fixedly inserted, and may be coupled to the lens barrel 210. Accordingly, the aperture 810 may move along with the lens barrel 210 and the lens holder 320.

The magnet 820 may be arranged on one side of the aperture 810. As an example, the magnet 820 may be mounted on the substrate 850 arranged on one side of the aperture 810 and may be disposed on one side of the aperture 810. The magnet 820 may be arranged on one side of the aperture 810 and may be disposed on the fourth surface of the lens holder 320. As an example, the magnet 820 may include two magnetic materials polarized from each other.

The substrate 850 may be coupled to the aperture 810 to move in the direction of the first axis (the Y axis). The substrate 850 may include a connection member which may be inserted into the aperture 810 and may move in the direction of the first axis (the Y axis) such that the substrate 850 may be coupled to the aperture 810 to move in the direction of the first axis (the Y axis). A diameter of an incident hole of an upper portion of the aperture 810 may change according to a degree of insertion of the connection member of the substrate 850, that is, a length of the substrate 850 and the aperture 810 in the direction of the first axis (the Y axis) such that an amount of light incident through the aperture 810 may be determined.

The coil 830 may be disposed on the fourth surface of the substrate 600 to oppose the magnet 820. The coil 830 may be disposed on the fourth surface of the substrate 600 and may generate driving force in the direction of the first axis (the Y axis). When driving force occurs in the direction of the first axis (the Y axis) by the magnet 820 and the coil 830, distances of the magnet 820 and the coil 830 taken in the direction of the first axis (the Y axis) may change.

The hall device 840 may oppose the magnet 820 on the fourth surface of the substrate 600. The hall device 840 may include a first hall device 841 and a second hall device 842 disposed with the coil 830 interposed therebetween. A flux value of the hall device 840 may change according to the movement of the magnet 820. A position of the magnet 820 may be detected from a flux value of the hall device 840.

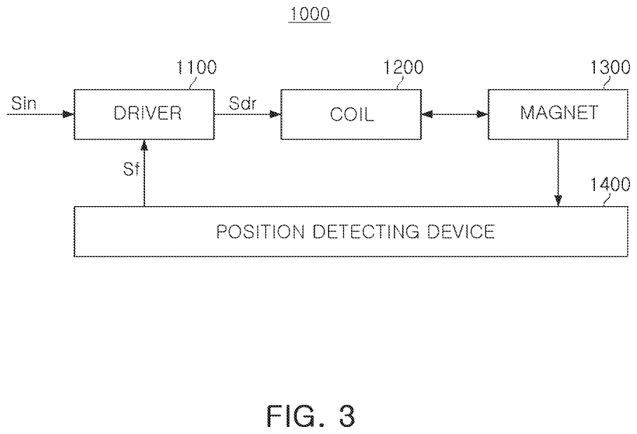

FIG. 3 is a block diagram illustrating an aperture module employed in a camera module according to an example. An aperture module 1000 in the example illustrated in FIG. 3 may correspond to the aperture module 800 illustrated in FIG. 2.

The aperture module 1000 may include a driver 1100, a coil 1200, a magnet 1300, and a position detecting device 1400.

The driver 1100 may generate a driving signal Sdr according to an input signal Sin applied from an external entity and a feedback signal Sf generated by the position detecting device 1400, and may provide the generated driving signal Sdr to the coil 1200. The input signal Sin may include information on a target position of the magnet 1300 corresponding to external illumination information of a camera module. An amount of light incident through an aperture may be determined according to a target position of the magnet 1300. As an example, the input signal Sin may be provided from an image processor which performs an image processing of an image signal generated by the image sensor. As another example, the input signal Sin may be provided from an illumination sensor arranged in a camera module.

When the driving signal Sdr provided from the driver 1100 is applied to the coil 1200, a diameter of an aperture may be determined by electromagnetic interaction between the coil 1200 and the magnet 1300.

The position detecting device 1400 may detect a position of the magnet 1300 moving by electromagnetic interaction between the coil 1200 and the magnet 1300 and may generate the feedback signal Sf, and may provide the feedback signal Sf to the driver 1100. As an example, the position detecting device 1400 may include a hall device for detecting a flux value.

When the feedback signal Sf is provided to the driver 1100, the driver 1100 may compare the input signal Sin with the feedback signal Sf and may generate the driving signal Sdr again. Accordingly, the driver 1100 may be driven based on a closed-loop type to compare the input signal Sin with the feedback signal Sf. The closed-loop type driver 1100 may be driven in a direction of reducing an error between a target position of the magnet 1300 included in the input signal Sin and a current position of the magnet 1300 included in the feedback signal Sf. The driving based on the closed-loop method may have improved linearity, accuracy, and repeatability as compared to an open-loop method.

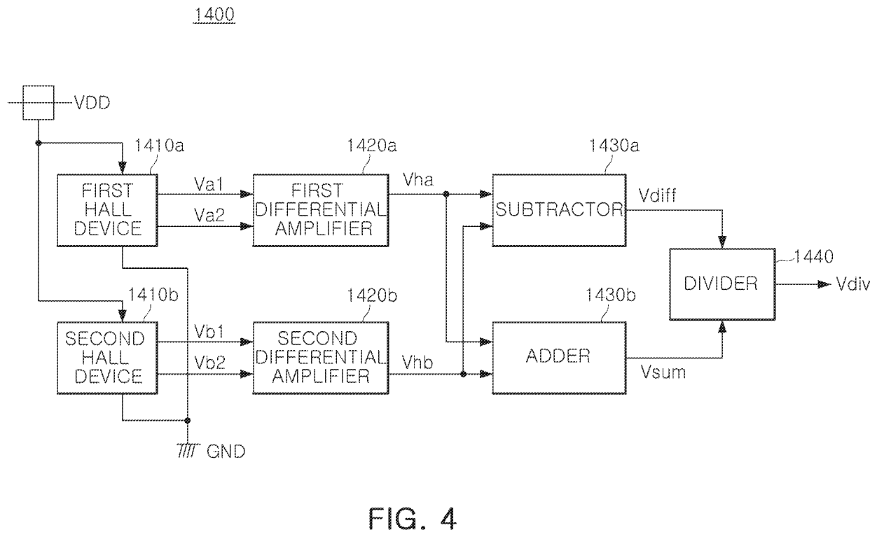

FIG. 4 is a block diagram illustrating a position detecting device according to an example.

Referring to FIG. 4, a position detecting device 1400 may include a first hall device 1410a, a second hall device 1410b, a first differential amplifier 1420a, a second differential amplifier 1420b, a subtractor 1430a, an adder 1430b, and a divider 1440.

When a driving voltage VDD is applied to the first hall device 1410a, the first hall device 1410a may output two output voltages Va1 and Va2. The first differential amplifier 1420a may differential-amplify the two output voltages Va1 and Va2 output by the first hall device 1410a and may generate a first hall voltage (Vha=Va1−Va2). Similarly, when the driving voltage VDD is applied to the second hall device 1410b, the second hall device 1410b may output two output voltages Vb1 and Vb2. The second differential amplifier 1420b may differential-amplify the two output voltages Vb1 and Vb2 output by the second hall device 1410b and may generate a second hall voltage (Vhb=Vb1-Vb2).

The subtractor 1430a may subtract the first hall voltage Vha and the second hall voltage Vhb and may output a subtraction voltage (Vdiff=Vha-Vhb), and the adder 1430b may add the first hall voltage Vha and the second hall voltage Vhb and may output an addition voltage (Vsum=Vha+Vhb).

The divider 1440 may output a division voltage (Vdiv=Vsum/Vdiff) according to a ratio of the addition voltage Vsum to the subtraction voltage Vdiff.

When the first hall voltage Vha of the first hall device 1410a and the second hall voltage Vhb of the second hall device 1410b are affected by a temperature coefficient T, the division voltage Vdiv may be represented by Equation 1 as below:

$$Vdiv = \frac{T * Vha + T * Vhb}{T * Vha - T * Vhb} \qquad [ Equation 1 ]$$

Referring to Equation 1, even when the first hall voltage Vha and the second hall voltage Vhb are affected by a temperature coefficient T, the temperature coefficient T may be erased according to a ratio of the addition voltage Vsum to the subtraction voltage Vdiff. Accordingly, in the example, the position detecting device 1400 may provide the addition voltage Vsum determined according to a ratio of the addition voltage Vsum to the subtraction voltage Vdiff as the feedback signal Sf, and may remove changes in hall voltage according to changes in temperature.

The divider 1440 may include a dual-slope integrating analog-to-digital circuit (ADC).

The dual-slope integrating ADC of the divider 1440 may calculate a ratio of the addition voltage Vsum to the subtraction voltage Vdiff in accordance with a charging time of a capacitor using the addition voltage Vsum and a discharging time of the capacitor using the subtraction voltage Vdiff.

The dual-slope integrating ADC of the divider 1440 may calculate a ratio of the addition voltage Vsum to the subtraction voltage Vdiff in accordance with a ratio between the charging time of the capacitor using the addition voltage Vsum and the discharging time of the capacitor using the subtraction voltage Vdiff.

As an example, when the capacitor having a first voltage level is charged according to the addition voltage Vsum, the dual-slope integrating ADC of the divider 1440 may calculate the charging time by measuring the time taken for a voltage of the capacitor to reach a second voltage level, and when the capacitor having a second voltage level is discharged according to the subtraction voltage Vdiff, the dual-slope integrating ADC may calculate the discharging time by measuring the time taken for a voltage of the capacitor to reach the second voltage level.

The addition voltage Vsum may be obtained by adding the first hall voltage Vha and the second hall voltage Vhb, and the subtraction voltage Vdiff may be obtained by subtracting the first hall voltage Vha and the second hall voltage Vhb. Accordingly, the charging time using the addition voltage Vsum may be different from the discharging time using the subtraction voltage Vdiff.

The dual-slope integrating ADC of the divider 1440 may include an integrator for performing the charging operation and the discharging operation described above, a counter for measuring the charging time and the discharging time, and others, and may be implemented by a generally used dual-slope ADC different from the above-described example.

A position detecting device 1000 in the example may convert the subtraction voltage Vdiff and the addition voltage Vsum digitally, and may operate by an analog method using the dual-slope integrating ADC of the divider 1440, rather than operating by a digital method of calculating a ratio of the addition voltage Vsum to the subtraction voltage Vdiff, thereby increasing accuracy in detecting the position, and reducing a size and a volume thereof as compared to the digital method.

Further, the position detecting device 1000 in the example may secure a voltage head room of the first hall device 1410a and the second hall device 1410b.

The voltage head room may be main properties which may improve sensitivity of the first hall device 1410a and the second hall device 1410b.

An N-well system resistor of a hall device may have properties of proportional to absolute temperature (PTAT) in which resistance increases as a temperature increases. Accordingly, when a temperature increases, a voltage head room may decrease in accordance with the increased resistance.

Also, neodymium of a hall device used for detecting a position may have properties of complementary to absolute temperature (CTAT) in which a magnetic field decreases as a temperature increases. Accordingly, as a magnetic field decreases when a temperature increases, a hall device may be driven by increasing a bias current.

When a bias current is increased, however, a decreased voltage head room may further decrease according to increased resistance.

Thus, the position detecting device 1000 in the example may sufficiently secure a voltage head room of the first hall device 1410a and the second hall device 1410b as compared to a method of controlling a bias current.

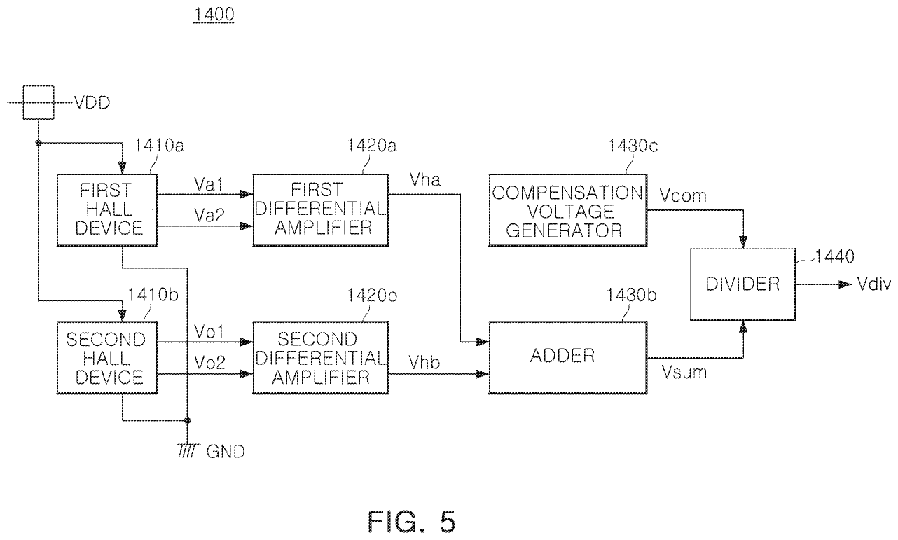

FIG. 5 is a block diagram illustrating a position detecting device according to an example.

A position detecting device in the example illustrated in FIG. 5 is similar to the position detecting device in the example illustrated in FIG. 4, and thus, overlapping descriptions will not be provided, and differences will mainly be described.

Referring to FIG. 5, a position detecting device 1400 may include a first hall device 1410a, a second hall device 1410b, a first differential amplifier 1420a, a second differential amplifier 1420b, an adder 1430b, a compensation voltage generator 1430c, and a divider 1440.

The compensation voltage generator 1430c may generate a compensation voltage Vcom having temperature properties the same as the temperature properties of an addition voltage Vsum.

The temperature properties of the addition voltage Vsum may be the same as the temperature properties of the first hall voltage Vha and the second hall voltage Vhb, and accordingly, a compensation voltage Vcom generated by the compensation voltage generator 1430c may have temperature properties the same as those of the first hall voltage Vha and the second hall voltage Vhb.

The divider 1440 may output a division voltage (Vdiv=Vsum/Vcom) according to a ratio of the addition voltage Vsum to the compensation voltage Vcom.

Thus, even when the first hall voltage Vha and the second hall voltage Vhb are affected by temperature coefficient T, the compensation voltage Vcom may have temperature properties the same as those of the addition voltage Vsum, the first hall voltage Vha, and the second hall voltage Vhb such that the temperature coefficient T may be erased according to a ratio of the addition voltage Vsum to the compensation voltage Vcom. Accordingly, in the example, the position detecting device 1400 may provide the division voltage Vdiv according to the ratio of the addition voltage Vsum to the compensation voltage Vcom as a feedback signal Sf and may remove changes in hall voltage caused by changes in temperature.

The divider 1440 in the example may include a dual-slope integrating ADC.

The dual-slope integrating ADC of the divider 1440 may calculate a ratio of the addition voltage Vsum to the compensation voltage Vcom in accordance with a charging time of a capacitor using the addition voltage Vsum and a discharging time of the capacitor using the compensation voltage Vcom.

When the addition voltage Vsum is equal to the compensation voltage Vcom, accuracy in detecting the position may decrease. Thus, the compensation voltage Vcom may be configured to have a voltage level different from that of the addition voltage Vsum, and accordingly, the charging time using the addition voltage Vsum may be different from the discharging time using the compensation voltage Vcom.

According to the aforementioned examples, the position detecting device of the aperture module may compensate for changes in hall voltage caused by changes in temperature.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A position detecting device, comprising:
a first hall device and a second hall device;
a subtractor configured to subtract a second hall voltage generated by the second hall device from a first hall voltage generated by the first hall device to generate a subtraction voltage;
an adder configured to add the first hall voltage to the second hall voltage to generate an addition voltage; and
a divider configured to calculate a ratio of the addition voltage to the subtraction voltage in accordance with a charging time of a capacitor using the addition voltage and a discharging time of the capacitor using the subtraction voltage.

2. The position detecting device of claim 1, wherein the divider comprises a dual-slope integrating analog-to-digital converter (ADC).

3. The position detecting device of claim 1, wherein the divider is configured to calculate the ratio of the addition voltage to the subtraction voltage in accordance with a ratio of the charging time to the discharging time.

4. The position detecting device of claim 1, wherein, in a case in which the capacitor has a first voltage level and is charged according to the addition voltage, the divider is configured to calculate the charging time by measuring a time taken for a voltage of the capacitor to reach a second voltage level.

5. The position detecting device of claim 4, wherein, in a case in which the capacitor has the second voltage level and is discharged according to the subtraction voltage, the divider is configured to calculate the discharging time by measuring a time taken for a voltage of the capacitor to reach the first voltage level.

6. The position detecting device of claim 1, wherein the charging time of the capacitor using the addition voltage is different from the discharging time of the capacitor using the subtraction voltage.

7. The position detecting device of claim 1, wherein changes in voltage according to temperatures of the first hall voltage and the second hall voltage are removed in accordance with the ratio of the addition voltage to the subtraction voltage.

8. The position detecting device of claim 1, further comprising:
a first differential amplifier configured to differential-amplify two output voltages of the first hall device to generate the first hall voltage; and
a second differential amplifier configured to differential-amplify two output voltages of the second hall device to generate the second hall voltage.

9. A position detecting device, comprising:
a first hall device and a second hall device;
an adder configured to add a first hall voltage generated by the first hall device to a second hall voltage generated by the second hall device to generate an addition voltage;
a compensation voltage generator configured to generate a compensation voltage having temperature properties that are the same as temperature properties of the addition voltage; and
a divider configured to calculate a ratio of the addition voltage to the compensation voltage in accordance with a charging time of a capacitor using the addition voltage and a discharging time of the capacitor using the compensation voltage.

10. The position detecting device of claim 9, wherein the divider comprises a dual-slope integrating analog-t0-digital converter (ADC).

11. The position detecting device of claim 9, wherein the divider is configured to calculate the ratio of the addition voltage to the compensation voltage in accordance with a ratio of the charging time to the discharging time.

12. The position detecting device of claim 9, wherein, in a case in which the capacitor has a first voltage level and is charged in accordance with the addition voltage, the divider is configured to calculate the charging time by measuring a time taken for a voltage of the capacitor to reach a second voltage level.

13. The position detecting device of claim 12, wherein, in a case in which the capacitor has the second voltage level and is discharged according to the compensation voltage, the divider is configured to calculate the discharging time by measuring a time taken for a voltage of the capacitor to reach the first voltage level.

14. The position detecting device of claim 9, wherein the charging time of the capacitor using the addition voltage is different from the discharging time of the capacitor using the compensation voltage.

15. The position detecting device of claim 9, wherein changes in voltage according to temperatures of the first hall voltage and the second hall voltage are removed in accordance with the ratio of the addition voltage to the compensation voltage.

16. The position detecting device of claim 9, further comprising:
a first differential amplifier configured to differential-amplify two output voltages of the first hall device to generate the first hall voltage; and
a second differential amplifier configured to differential-amplify two output voltages of the second hall device to generate the second hall voltage.

17. A camera module, comprising:
a lens barrel; and
an aperture module configured to adjust an amount of light incident to the lens barrel, the aperture module comprising:
a coil;
a magnet that opposes the coil along a first direction perpendicular to an optical axis;
a first hall device configured to generate a first hall voltage;
a second hall device configured to generate a second hall voltage; and
a position detection device configured to detect a current position of an aperture of the aperture module by sensing a position of the magnet based on a ratio of a sum of the first hall voltage and the second hall voltage to a difference between the first hall voltage and the second hall voltage,
wherein, the position detection device comprises a divider configured to calculate a ratio of the subtraction-addition voltage to the addition-subtraction voltage in accordance with a charging time of a capacitor using the addition voltage and a discharging time of the capacitor using the subtraction voltage.

18. The camera module of claim 17, wherein the first hall device is disposed on a first side of the coil along a second direction that is perpendicular to the first direction and the optical axis, and the second hall device is disposed on a second side of the coil along the second direction.
